(19) United States
(12) Patent Application Publication
(10) Pub. No.: US 2007/0039595 A1
(43) Pub. Date: Feb. 22, 2007

(54) Air intake device and fuel in-line device for improved combustion

(76) Inventor: Kai Chuan Lim, Singapore (SG)

Correspondence Address: NIELDS & LEMACK, 176 EAST MAIN STREET, SUITE 7, WESTBORO, MA, 01581, US

(21) Appl. No.: 11/442,484

(22) Filed: May 26, 2006

(30) Foreign Application Priority Data
Aug. 16, 2005 (SG) 2005 05167-7

(51) Int. Cl. F02M 27/00; F02B 23/00; F02M 35/02

(52) U.S. Cl. 123/538; 123/198 E; 123/585

(57) ABSTRACT

A method to improve combustion in an internal combustion engine, comprising a first step of installing an air intake device fitted onto a T-Joint leading to the intake manifold of the internal combustion engine, for intake of additional air from the surrounding for improved intake of air into the internal combustion engine; and a second step of installing a fuel in-line device by connecting it to a fuel line from the fuel tank to the internal combustion engine. An air intake device and a fuel in-line device is also proposed.

### TECHNICAL FIELD OF THE INVENTION

The present invention relates to an air intake device used in conjunction with a fuel in-line device for improved combustion in internal combustion engines.

### BACKGROUND OF THE INVENTION

Oxygen is needed for internal combustion engines to release the chemical energy from hydrocarbon fuel. The oxygen is from the air in the atmosphere taken into the internal combustion engine.

Atmospheric air consists of approximately 21 percent oxygen, 78 percent nitrogen and minute amount of inert gases. When the ideal air/hydrocarbon fuel ratio for optimum combustion is attained by the internal combustion engine, the internal combustion engine operates at maximum fuel economy and maximum engine performance. An air/fuel ratio less than ideal will result in lower fuel economy and higher emissions. An air/hydrocarbon fuel ratio greater than the ideal air/fuel ratio will result in lesser power, drivability and higher emissions.

Internal combustion engines are factory tuned to function at a higher degree of hydrocarbon fuel to air ratio to cater to the varying levels of hydrocarbon fuel quality worldwide Having this as a default setting has resulted in engines underperforming.

Various devices have been proposed to improve air/hydrocarbon fuel ratio for internal combustion engines. One type of device is directed towards using sensors in attempts to precisely control the internal combustion process in the internal combustion engine. One example is UK Patent GB 2 346 457 A. Another type of device is directed towards devices to improve mixing of fuel with air. A fuel-air mixture device has been described in PCT/IB99/01214 with the use of an apertured vaporization block with one or more air passages. These devices suffer from certain drawbacks. One drawback is that the device proposed is complex and has to be installed by trained mechanics. Another drawback is that such devices have many parts and is costly. Another drawback observed is that the device has to be installed inside the internal combustion engine. However, such devices are not popular as car manufacturers could void warranties for cars installed with such devices.

### PROBLEM TO BE SOLVED

A simple air intake device with an one-way valve to improve air/hydrocarbon fuel mixture and which could be easily installed outside the main internal combustion engine is desirable. An air intake device which is not only easy to install but is simple to manufacture could offer significant savings to the motorist.

The inventor has found in the course of research that an air intake device is alone not sufficient to give improved combustion. A simple “in-line device” installed along the fuel line just before the hydrocarbon fuel enters the engine is also preferred.

A simple air intake device consisting of a few parts which basically improves the intake of additional air into the intake manifold and this the cylinders of the internal combustion engine without the need to tune or adjust the device is desired. The simple air intake device should also be easily and quickly installed even by a motorist without much technical knowledge.

The air intake device used in conjunction with the hydrocarbon fuel in-line device offers better fuel economy and improved power for the internal combustion engine.

A fuel in-line device that is small enough to fit along the fuel line without the need for mounting brackets is also desired.

### MEANS TO SOLVE THE PROBLEM

A simple air intake device consisting of a few parts which basically improves the air/fuel ratio of internal combustion engines by the intake of additional air into the intake manifold is desired. Since the air intake device is a simple device consisting of a few parts, it can be manufactured at a low cost. The simple air intake device is also easily and quickly installed even by a motorist without much technical knowledge. Finally, the device when installed will not result in the voiding of any car manufacturer's warranty.

### SUMMARY OF THE INVENTION

A first object of the invention is a method to improve combustion in an internal combustion engine, comprising the steps:—
installing an air intake device fitted onto a T-Joint leading to the intake manifold of the internal combustion engine, for admitting auxiliary improved intake of air into the internal combustion engine and which is dependent upon the level of vacuum in the manifold; and
installing a fuel in-line device by connecting it to a fuel line from the fuel tank to the internal combustion engine.

A second object of the invention is an air intake device, consisting of
an air intake filter;
a hollow cylindrical metal body having an upper body, lower body and a connector, an upper chamber inside the upper body, a lower chamber inside the lower body and an air duct inside the connector, said upper chamber, lower chamber and air duct forming a passage for air;
a sponge fitted inside the upper chamber;
a metal disc and a resilient spring fitted inside the lower chamber;
   wherein additional air is drawn from the surrounding into the air intake filter, through the upper chamber, lower chamber, air duct to join air taken by the vacuum servo hose, in order to improve combustion of the internal combustion engine.

A third object of the invention is a fuel in-line device, consisting of
a first section connected to an inlet for fuel leading from the fuel tank,
a middle tubular hollow section leading from the first section;
a third section connected to an outlet for fuel flowing to the engine.

Preferably, the fuel in-line device has a first hollow section with a stainless steel wire mesh chamber containing at least four catalytic pellets.

Preferably, the third section is of a narrower cross section than the outlet for fuel leading from the third section to the fuel tank.

Preferably, the air intake device is connected by the T-joint to a vacuum servo hose or an inlet leading into the intake manifold.

Preferably when the throttle of the internal combustion engine is stepped, a suction force provided by the internal combustion engine increases, drawing the disc in the air intake device in the lower chamber to push down on the resilient spring, causing a bigger void in the lower chamber, the bigger void causing additional air to be drawn through the air intake filter, into the upper chamber, through the lower chamber and the air duct to join air taken by the vacuum servo hose, thereby improving combustion in the internal combustion engine.

Preferably when the throttle of the internal combustion engine is released, a suction force provided by the internal combustion engine decreases, causing the resilient spring of the air intake device to push against the top of the lower chamber, causing a smaller void in the lower chamber, the smaller void reducing the amount of additional air to be drawn through the air intake filter, into the upper chamber, through the lower chamber and the air duct to join air taken by the vacuum servo hose, thereby reducing the amount of combustion in the internal combustion engine.

Preferably the air intake filter of the air intake device filters dust and air particles drawn in together with the additional air before allowing the additional air to pass through the air intake device.

Preferably the sponge in the air intake device removes remaining dust and air particles drawn in together with the additional air after said air had passed through the air intake filter, before allowing the said air to pass into the vacuum servo hose and into the intake manifold.

Preferably, the sponge fitted into the upper chamber of the air intake device has a mesh to prevent bits of the sponge from entering the lower chamber.

Advantageously the air intake filter of the air intake device is threadingly screwed to the hollow cylindrical metal body and sealed with a rubber O-ring, so that the air intake filter can be unscrewed and the dust and air particles removed from the sponge before being used again.

Advantageously the air intake filter of the air intake device is threadingly screwed to the hollow cylindrical metal body and sealed with a rubber ring, such that the air intake filter can be unscrewed and replaced with another new air intake filter as and when desired.

Preferably, the air intake filter of the air intake device is threadingly screwed to the hollow cylindrical metal body and sealed with a rubber ring, such that the air intake filter can be unscrewed and the sponge replaced with another new sponge as and when desired.

### BRIEF DESCRIPTION OF DRAWINGS

FIG. 1 shows an internal combustion engine fitted with the air intake device in another location.

FIG. 2 shows an internal cross section of a main embodiment of the air intake device.

FIG. 3 shows a front view of the main embodiment of the air intake device.

FIG. 4 shows a front view of a second embodiment of the air intake device.

FIG. 5 shows a cross sectional view of the components of the fuel in-line device.

FIG. 6 shows a first location of the fuel in-line device.

FIG. 7 shows a second location of the fuel in-line device.

FIG. 8 is a chart showing a test vehicle's power output and torque across the rev range of a saloon car tested with the air intake device and fuel in line device.

### DESCRIPTION OF THE PREFERRED EMBODIMENTS

An embodiment of the present invention will now be described with reference to the accompanying drawings.

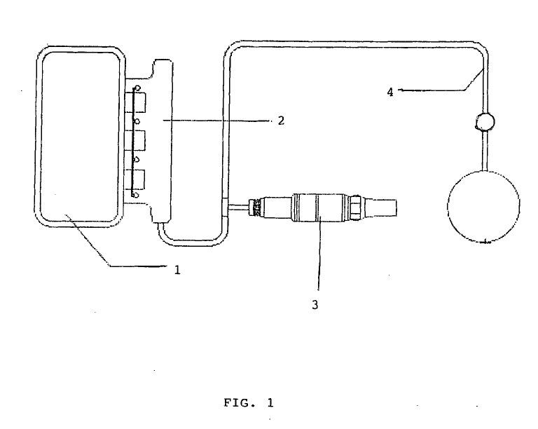

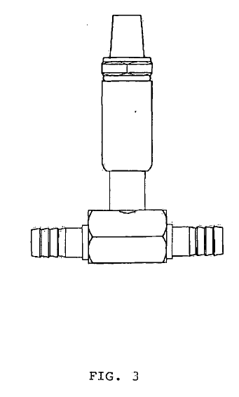

FIG. 1 is an overhead view of a typical internal combustion engine (not to scale) with the main components and air intake device shown. The engine 1 has the intake manifold 2 connected and leading into the internal combustion engine. Fuel introduced into the carburetor from the petrol tank (not shown) is then mixed with the additional air from the vacuum servo hose 4. Various locations may be proposed for the fitting of the air intake device 3. The air intake device 3 of the present invention can also be fitted onto internal combustion engines using fuel injection. The air intake device 3 is similarly fitted into the vacuum servo hose 4 leading into the intake manifold 2, using a T-joint connection, as shown in FIG. 3.

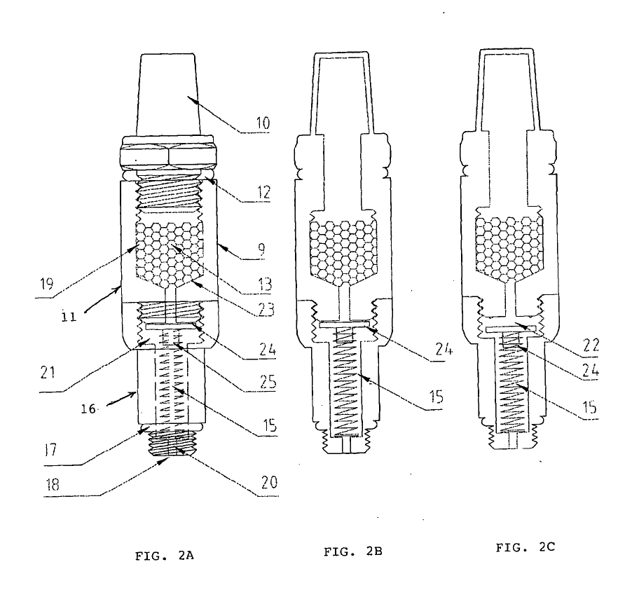

FIG. 2A shows an air intake device of the present invention. FIG. 2B shows the air intake device in operation when the air intake device is in a closed position. FIG. 2C shows the air intake device in an opened position.

The throttle controls the air entering the intake manifold 2 which subsequently mixes with fuel to form a combustible mixture in the cylinders of the engine. A simple air intake device with a one way valve can be attached to the point where the vacuum hose attaches to the intake manifold. This device requires a relatively simple “plug and drive” setup. The valve admits controlled amount of air into the intake manifold 2 depending on the level of vacuum in the intake manifold 2. The valve opens and closes to varying degree in response to changes in the air pressure in the intake manifold 2. The volumetric efficiency of the engine is increased.

A “Venturi” effect creates turbulence in the intake manifold 2, enhancing the atomization of the air fuel mixture. Combustion occurs at closer to an ideal mixture of air and hydrocarbon fuel. This leads to better fuel economy, increased engine power (improved acceleration and throttle response).

FIG. 2A shows an internal cross section of the main embodiment of the air intake device. The air intake device 3 consists of three components—an air intake filter 10 at the front end connected threadingly by a rubber O-ring 12 to a hollow cylindrical metal body 9. The hollow cylindrical metal body 9 has a wider upper body 11 and a lower narrower body 16 which is threadingly connected to a lower hollow connector 17. The upper body 11 consists of a wider chamber and the lower body 16 consists of a narrower chamber. The connector 17 has an air duct 20 which leads to an orifice 18 at its base. The upper chamber 19, lower chamber 21 and air duct 20 forms an air passage for additional air intake from outside the engine to flow through the vacuum servo hose 4, into the carburettor 3. The upper chamber 19 is fitted tightly with a sponge 13. The base of the sponge 13 has a fine mesh 23 to prevent bits of the sponge 13 torn off by the suction force going through the air intake device 3 from entering the lower chamber 21 and possibly jamming the resilient spring 15. The lower chamber 21 is fitted with a resilient spring 15 and a disc 24. The disc 24 in turn presses against the resilient spring 15, in its normal relaxed position.

FIG. 2 B shows the air intake device in a closed position. In this position, pressing the throttle creates a suction and additional air from the surrounding is taken into the air intake device 3 through the air intake filter 10, through the upper chamber 19, lower chamber 21, air duct 20, out of the orifice 18 at the base of the connector 17, into vacuum servo hose 4 and finally into the intake manifold 2. The suction force of the internal combustion engine pulls the disc 24 down, resulting in the disc 24 pushing against the resilient spring 15. A void is then created within the lower chamber 21, causing additional air from outside the engine to be sucked into the air intake filter 10, through the upper 19 and lower 21 chambers, through the air duct 20 and into the vacuum servo hose 4 and finally into the intake manifold 2. As a result, more air would be forced into the intake manifold 2 for mixing with the fuel, with the additional air taken through the air intake device 3. The orifice 18 at the base of the connector 17 also provides turbulence to the additional air as the additional air rushes into the intake manifold 2, allowing air and fuel to mix more thoroughly, creating a “Venturi” effect. The combustion of fuel and air (the volume of which has been increased by the additional air taken through the air intake device) inside the internal combustion engine results in a more complete combustion of the fuel, improving combustion as well as reducing the amount of unburnt carbon emitted from the internal combustion engine. This leads to better fuel economy, increased engine power giving improved acceleration and throttle response.

FIG. 2 C shows the air intake device in an opened position. In this position, slight release of the throttle creates less suction and the amount of additional air from the surrounding taken into the air intake device 3 is lesser. The disc 24 is now pushed upwards by the resilient spring 15, closing any void within the lower chamber 21. The combustion of fuel and air (without any increased by the additional air taken through the air intake device) is now sufficient for the combustion of the fuel within the internal combustion engine. This results in a more complete combustion of the fuel, improving combustion as well as reducing the amount of unburnt carbon emitted from the internal combustion engine.

FIG. 3 shows a front view of the main embodiment of an air intake device. In this embodiment, an air intake device is shown to be connected to the internal combustion engine.

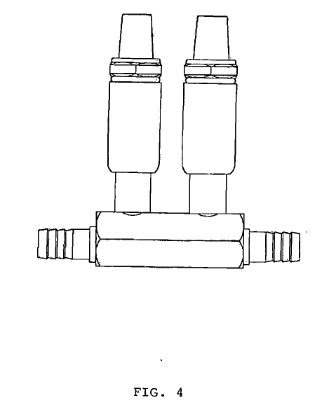

FIG. 4 shows a second embodiment of the air intake device. In the second embodiment, two air intake devices are proposed for installation onto a internal combustion engine.

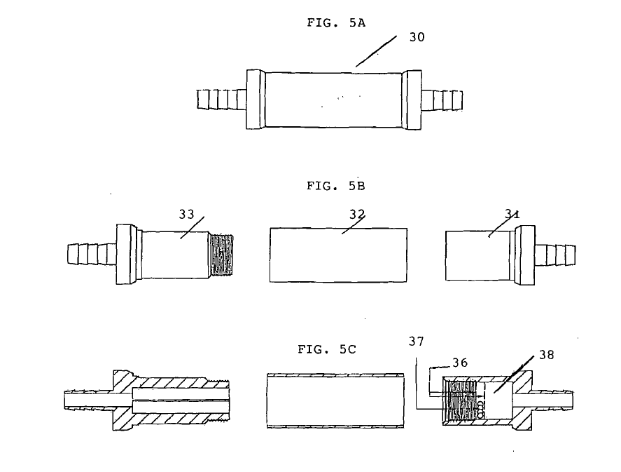

FIG. 5 shows a cross section view of the components of the fuel in-line device. FIG. 5A shows a side view of the fuel in-line device. FIG. 5B shows the fuel in-line device in its three components. FIG. 5C shows a cross section of the three components of the fuel in-line device.

The fuel in-line device 30 consists of three hollow tubular sections, the first hollow section 31 and third hollow section 33 for connection to a portion of the fuel pipe 43 leading from the fuel tank to the engine. Ideally, the fuel in-line device 30 must be placed near the engine and within the engine compartment. The first hollow section 31 also contains a chamber 38 made of stainless steel wire mesh 36 with at least four catalytic pellets 37 contained therein. The cross section of the third hollow section 33 of the fuel in-line device is narrower than the fuel pipe 43 leading out to the engine. Fuel from the fuel tank in passing through the first hollow section 31 is thus forced through the narrower hollow first section. The fuel molecules are thus agitated as the fuel is “squeezed” through the narrow first hollow section 31. As the fuel passes through the stainless steel wire mesh chamber 36, the fuel molecules are further agitated by the moving catalytic pellets 37. The agitated fuel molecules are then heated up as it enters the mid second section 32 of the fuel in-line device. Heat from the engine compartment further heats exterior wall of the hollow mid section 32, thus increasing the temperature of the fuel molecules. Overall, the temperature of the fuel would have been increased by the time it leaves the third hollow section for the engine as compared to its original temperature when the fuel was stored in the fuel tank.

The fuel in-line device 30 also serves as a reservoir for fuel to flow into prior to entering the engine. The heat generated by the engine itself serves to increase the kinetic energy of fuel molecules in the in-line device. When fuel passes through the device, the enthalpies of the fuel molecules are raised, bonds are stretched. Less clustering of fuel molecules occurs causes expansion of the fuel molecules increasing more surface areas of the fuel molecules. More surface areas are therefore exposed for oxygen at the time of combustion. Again, the combustion of fuel and air inside the internal combustion engine results in a more complete combustion. Combustion is now made more complete and less unburned fuel goes out of the exhaust as polluting emissions. Better fuel economy and engine power is achieved.

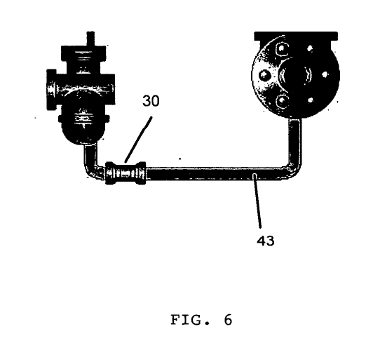

FIG. 6 shows a first location for installation of the fuel in-line device in a motor cycle. In this case, the fuel in-line device is positioned along the fuel line 43 a little distance from the carburetor.

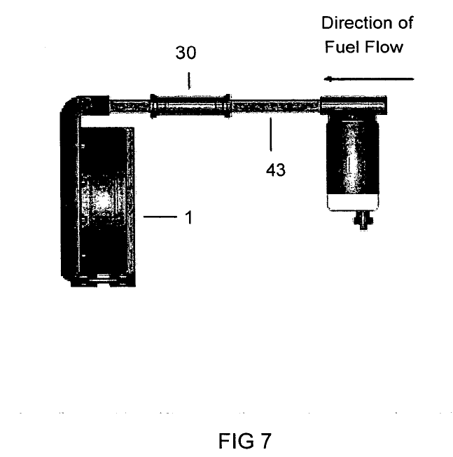

FIG. 7 shows a second possible location for installation of the fuel in-line device. In this case, the fuel in-line device is installed on a diesel engine and positioned along the fuel line 43 a little distance from the main engine 1.

Having described the various components of the air intake device 3, an operation of the air intake device will now be described with reference to the drawings.

A typical engine 1 as shown in FIG. 1. The engine 1 has an the air intake manifold 2 connected and leading into the internal combustion engine. Fuel introduced into the carburettor from the petrol tank (not shown) which is then mixed with the air from the vacuum servo hose 4.

The ideal combustion results when air and fuel are introduced into the internal combustion engine with the fuel completely burnt within the internal combustion engine. When the ideal combustion results, the internal combustion engine achieves optimum fuel economy and there is virtually no unburnt carbon. If for some reason, the amount of air and fuel is not at the ideal combustion result, it could result in poor fuel economy (wastage of unburnt fuel) with more emissions of unburnt fuel into the atmosphere. For instance, there could be too much air and too little fuel. Or it could be a case of too little air and too much fuel. Whatever the cause, the end result would be lesser power for the engine, poorer drivability and more emissions of unburnt fuel.

The present invention is able to offer improved emissions, better fuel economy and good engine performance in internal combustion engines and at the same time is simple to install and remove. It has a few parts and therefore is low cost.

The air intake device is fitted to an existing joint in the vacuum servo hose 4 or any inlet going into the intake manifold 2 and is unlikely to void any manufacturer's warranty for the internal combustion engine.

The air intake device 3 of the present invention can also be fitted onto internal combustion engines using fuel injection. The air intake device 3 is similarly fitted into the vacuum servo hose 4 leading into the intake manifold 2, using a T-joint connection, as shown In FIG. 3. Operation of the air intake device 3 is similar when used with fuel injection engines and would not be repeated herein.

Next an operation of the fuel in-line device will now be described with reference to the drawings. The fuel in-line device can be installed by connecting it to the fuel pipe. Fuel from the fuel tank passing through the first hollow section is thus forced through the narrow inlet. The fuel molecules are thus agitated as the fuel is “squeezed” through the hollow first section. As the fuel passes through the stainless steel wire mesh chamber, the fuel molecules are further agitated by the moving catalytic pellets. The fuel molecules also further heated up as it enters the hollow mid section of the fuel in-line device, the heat from the engine compartment heating the hollow mid section, and the heat from the engine compartment further transmitted to the fuel molecules.

The fuel in-line device also serves as a reservoir for fuel to flow into prior to entering the engine. The heat generated by the engine itself serves to increase the kinetic energy of fuel molecules in the fuel in-line device When fuel passes through the in-line device, the enthalpies of the fuel molecules are raised, bonds are stretched. Less clustering of fuel molecules occurs. More surface areas are exposed for oxygen at the time of combustion. Combustion is more complete, less unburned fuel goes out of the exhaust as polluting emissions. Better fuel economy and engine power is achieved.

In the case of the first embodiment (FIG. 6), the fuel in-line device 30 is fitted along the fuel line 43 leading from the fuel pump 42 to the carburetor 3. In the case of the second embodiment (FIG. 7), for a diesel engine, the fuel in-line device 30 can be fitted on the diesel feed line (fuel line 43) on its passage to the engine.

The combined working of the air in-take device and fuel in-line device serves to improve fuel efficiency in the internal combustion engine. The air-intake device increases the air intake thus improving combustion of the air/hydrocarbon mixture. This leads to better fuel economy, increased engine power (improved acceleration and throttle response).

The use of the fuel in-line device also assist in contributing to better combustion of the fuel. The enthalpies of the fuel molecules are raised stretching the bonds between the fuel molecules. Less clustering of the fuel molecules occurs resulting in these molecules being readily burnt through the combustion process in the engine.

The air intake device 3 of the present invention has been fitted into a saloon car to test the effect of the air intake device on engine horsepower, torque and emissions improvement.

Details of Test Vehicle

Manufacturer: Toyota
Model: Corolla Altis Sedan (Year: 2001)
Engine: 3ZZFE (1598cc)

An additional mileage test was conducted on a second passenger vehicle with the following specifications:—

Details of Test Vehicle

Manufacturer: Daihatsu
Model: Terios SUV (4WD) (Year: 2000)
Engine: HC-EJ (1296cc)

The test showed that with the use of the air intake device, a maximum 3.9% increase in power and a maximum torque of 3.8% were reported. As for fuel economy, an increase of 16.5% in fuel economy was reported.

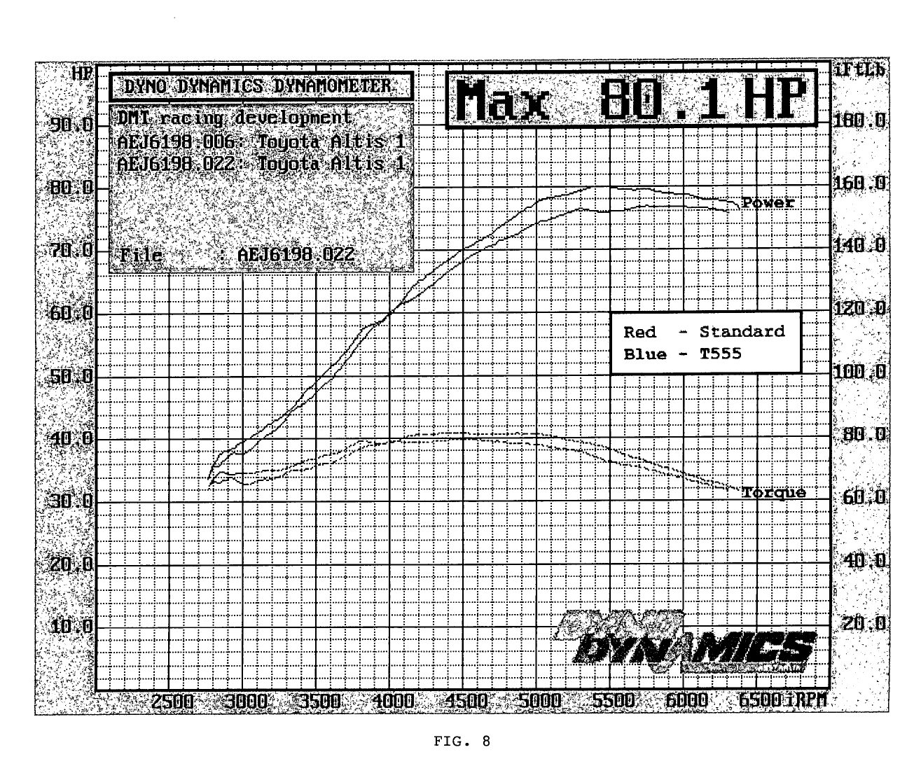

With reference to FIG. 8, with \textcircled{1} indicating results with the device installed, \textcircled{2} indicating results without the device, it was observed that the device boosted the vehicle's power output and torque across the rev range.

The above data indicates that a fuel savings of 16.5% was achieved. However, it should be noted that test runs conducted over longer distances will provide more accurate results, as the sensors in fuel pumps can be quite inconsistent in cutting off during full refills.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

Advantageous Effects of the Invention

An air intake device which can be easily fitted into the vacuum servo hose or any inlet going into the intake manifold of an internal combustion engine. Once installed, it is easy to maintain. The device is also simple to manufacture and have a few parts, and consequently made at a low cost. By bringing about more complete combustion, better engine torque and better fuel efficiency is attained.

The use of an additional fuel in-line device would also contribute to improvement in fuel economy of an internal combustion engine. The combined effect of the air intake device and fuel in-line device offers improved fuel economy, improved power and torque as compared to singular use of the air intake device and also when compared to a typical car without any of these two devices.

1. A method to improve combustion in an internal combustion engine having an intake manifold, comprising:
installing an air intake device fitted onto a T-Joint leading to said intake manifold of said internal combustion engine, for admitting auxiliary air into the internal combustion engine and which is dependent upon the level of vacuum in said manifold; and
installing a fuel in-line device by connecting it to a fuel line from a fuel tank to said internal combustion engine.

2. An air intake device for an internal combustion engine having a vacuum servo hose, comprising:
an air intake filter;
a hollow cylindrical metal body having an upper body, lower body and a connector, an upper chamber inside the upper body, a lower chamber inside the lower body and an air duct inside the connector, said upper chamber, lower chamber and air duct forming a passage for air;
a sponge fitted inside the upper chamber;
a metal disc and a resilient spring fitted inside the lower chamber;
wherein additional air is drawn from the surrounding air into said air intake filter, through said upper chamber, lower chamber, and air duct to join air taken by said vacuum servo hose, in order to improve combustion in said internal combustion engine.

3. A fuel in-line device for an engine having a fuel tank, comprising:
a first section connected to an inlet for fuel leading from said fuel tank;
a middle tubular hollow section leading from said first section; and
a third section connected to an outlet for fuel flowing to said engine.

4. A fuel in-line device as claimed in claim 3, wherein said first section has a hollow stainless steel wire mesh chamber containing at least four catalytic pellets.

5. A fuel in-line device as claimed in claim 3, wherein said third section is of a narrower cross section than said outlet for fuel leading from said third section to said fuel tank.

6. An air intake device as claimed in claim 2, which is connected by a T-joint to said vacuum servo hose or an inlet leading into an intake manifold of said engine.

7. An air intake device as claimed in claim 2, further comprising a throttle for said internal combustion engine, and wherein when said throttle of the internal combustion engine is actuated, a suction force provided by the internal combustion engine increases, causing the disc in the lower chamber to push down on the resilient spring, increasing the void in the lower chamber, the increased void causing additional air to be drawn through the air intake filter, into the upper chamber, through the lower chamber and the air duct to join air taken by said vacuum servo hose, thereby improving combustion in the internal combustion engine.

8. An air intake device as claimed in claim 2, further comprising a throttle for said internal combustion engine, and wherein when said throttle of the internal combustion engine is released, a suction force provided by the internal combustion engine decreases, causing the resilient spring to push against the top of the lower chamber, decreasing a void in the lower chamber, the decreased void reducing the amount of additional air to be drawn through the air intake filter, into the upper chamber, through the lower chamber and the air duct to join air taken by said vacuum servo hose, thereby reducing the combustion in the internal combustion engine.

9. An air intake device as claimed in claim 2, wherein the air intake filter filters dust and air particles drawn in together with the additional air before allowing the additional air to pass through the air intake device.

10. An air intake device as claimed in claim 2, wherein said sponge further removes remaining dust and air particles drawn in together with the additional air after said air had passed through the air intake filter, before allowing the said air to pass into said vacuum servo hose and into the intake manifold.

11. An air intake device as claimed in claim 2, wherein said sponge has a base, and said base of the sponge comprises mesh to prevent bits of the sponge from entering the lower chamber.

12. An air intake device as claimed in claim 2, wherein the air intake filter is threadingly screwed to the hollow cylindrical metal body and sealed with a rubber ring, so that the air intake filter can be unscrewed and the dust and air particles removed from said air intake filter before being used again.

13. An air intake device as claimed in claim 2, wherein the air intake filter is threadingly screwed to the hollow cylindrical metal body and sealed with a rubber ring, so that the air intake filter can be unscrewed and the dust and air particles removed from the sponge before being used again.

14. An air intake device as claimed in claim 2, wherein the air intake filter is threadingly screwed to the hollow cylindrical metal body and sealed with a rubber ring, such that the air intake filter can be unscrewed and replaced with another new air intake filter as and when desired.

15. An air intake device as claimed in claim 2, wherein the air intake filter is threadingly screwed to the hollow cylindrical metal body and sealed with a rubber ring, such that the air intake filter can be unscrewed and the sponge replaced with another new sponge as and when desired.
